(19) United States
(12) Patent Application Publication
(10) Pub. No.: US 2001/0056052 A1
(43) Pub. Date: Dec. 27, 2001

(54) Cleaning liquid

(75) Inventors: Hidemitsu Aoki, Tokyo (JP); Masayuki Takashima, Chiba (JP)

Correspondence Address: BIRCH STEWART KOLASCH & BIRCH, PO BOX 747, FALLS CHURCH, VA, 22040-0747, US

(73) Assignee: NEC Corporation

(21) Appl. No.: 09/916,512

(22) Filed: Jul. 30, 2001

Related U.S. Application Data
(62) Division of application No. 09/551,727, filed on Apr. 18, 2000.

(30) Foreign Application Priority Data
Apr. 20, 1999 (JP) 112106/1999

(51) Int. Cl. C11D 17/08

(52) U.S. Cl. 510/175; 510/409

(57) ABSTRACT

A cleaning liquid for cleaning a substrate having, on its surface, a plurality of exposed insulating films comprising silicon dioxide containing impurities in different concentrations, which comprises an organic alkaline amine compound and hydrogen peroxide. After cleaning with such a cleaning liquid, no step is formed between the insulating films containing impurities in different concentrations.

### BACKGROUND OF THE INVENTION

1. Field of the Invention

The present invention relates to a cleaning liquid comprising an organic alkaline amine compound and hydrogen peroxide. In particular, the present invention relates to a cleaning liquid which is used to clean a substrate having, on its surface, a plurality of exposed insulating films comprising silicon dioxide containing impurities in different concentrations.

2. Background Art

In a method for the production of devices on a semiconductor substrate, it is necessary to clean the semiconductor substrate to remove contaminants or metallic impurities adhered to the substrate surface. A cleaning liquid comprising ammonia and hydrogen peroxide is known as a cleaning liquid which is generally used in a cleaning step to remove, in particular, fine particles and deposits.

In a method for the production of semiconductor devices, many structures such as capacitors, wirings, etc. are piled or coated. Thus, insulating films having high surface evenness are used in the course of the production method. To form insulating films having high evenness, silicon dioxide films containing boron and phosphorus (BPSG) are used, while it is preferable for insulating films directly covering gates or capacitors to contain neither boron nor phosphorus. An amount of impurities to be contained in materials which form gates or capacitors is strictly governed to control the device performances. However, if films containing impurities are allowed to be in direct contact with the gates or capacitors, the impurities may diffuse in the gates or capacitors, and thus the concentration of impurities in the materials constituting the gates or capacitors may change. Thus, insulating films which directly cover the gates or capacitors should be those containing no impurities. Accordingly, the cross section of a device has a laminated structure comprising an insulating film which consists of silicon dioxide containing neither boron nor phosphorus (NSG) (a non-doped oxide film), and an insulating film which consists of silicon dioxide containing boron or phosphorus (BPG or PSG) or an insulating film which consists of silicon dioxide containing both boron and phosphorus (BPSG) (doped oxide films).

In a step to form connection plugs which penetrate the laminated structure in the thickness direction, when holes for the plugs are bored by dry etching, both the doped oxide films and the non-doped oxide films are exposed on the inner surfaces of the holes. After dry etching, most of a resist used for patterning is removed by ashing with oxygen plasma and cleaning with a mixture of sulfuric acid and hydrogen peroxide. However, deposits formed by dry etching are not removed and remain on the surfaces outside the holes, and the inside of the holes. Thus, cleaning to remove such remained deposits is necessary.

When a semiconductor substrate having the above structure is cleaned with a cleaning liquid containing ammonia and hydrogen peroxide (APM cleaning liquid), the steps are formed between the two types of insulating films as shown in FIG. 2B, so that no smooth cleaned surfaces are obtained, since the etching rate of the doped oxide films is faster than that of the non-doped insulating films. In addition, the etching rates of doped insulating films containing different amounts of boron and/or phosphorous are also different. Thus, the same problem as above may arise.

Steps are formed on the inner walls of the holes, when the holes having a structure such that both the doped oxide films and the non-doped oxide films expose on the inner walls of the holes are treated with a conventional cleaning liquid comprising ammonia and hydrogen peroxide.

When the steps are formed on the inner walls of the holes, it is difficult to fill the interiors of plugs with a conductive material, and thus the reliability of the devices decreases.

The formation of the steps is not regarded as a serious problem for the devices having holes with a diameter of 0.5 μm or more, although the steps are formed in the conventional method for the production of such devices. However, with the increase of the degree of miniaturization of devices, the diameter of the above hole is decreased, and thus the sizes of formed steps cannot be ignored in comparison with the diameter of the hole.

### SUMMARY OF THE INVENTION

An object of the present invention is to provide a cleaning liquid suitable for cleaning a substrate, in particular, a substrate having, on its surface, a plurality of exposed insulating films comprising silicon dioxide containing impurities in different concentrations.

Accordingly, the present invention provides a cleaning liquid comprising an organic alkaline amine compound and hydrogen peroxide.

### BRIEF DESCRIPTION OF THE DRAWINGS

FIGS. lA and lB schematically show the cross section of a substrate having a hole before and after cleaning with the cleaning liquid of the present invention, respectively. FIGS. 2A and 2B schematically show the cross section of a substrate having a hole before and after cleaning with a conventional APM cleaning liquid.

### DETAILED DESCRIPTION OF THE INVENTION

Examples of the organic alkaline amine compound contained in the cleaning liquid of the present invention include tetraalkylammonium hydroxides, and trialkyl(hydroxyalkyl)ammonium hydroxides.

Specific examples of the tetraalkylammonium hydroxides are tetramethylammonium hydroxide, tetraethylammonium hydroxide, tetrapropylammonium hydroxide, etc. Specific examples of the trialkyl(hydroxyalkyl)ammonium hydroxides are hydroxyethyltrimethylammonium hydroxide, 2-hydroxyethyltrimethylammonium hydroxide, etc. These ammonium hydroxides may be used independently or in admixture of two or more of them.

Other examples of the organic alkaline amine compound include monomethylamine, dimethylamine, trimethylamine, monoethylamine, diethylamine, triethylamine, monoethanolamine, diethanolamine, triethanolamine, isopropylamine, diisoproylamine, triisopropylamine, isopropanolamine, diisopropanolamine, triisopropanolamine, ethylenediamine, diethylenetriamine, triethylenetetramine, tetraethylpentamine, etc. These amines may be used independently or in admixture of two or more of them.

Furthermore, all the above organic alkaline amine compounds may be used independently or in admixture of two or more of them.

Among these organic alkaline amine compounds, tetramethylammonium hydroxide is particularly preferable since, when a cleaning liquid containing this tetraalkyl ammonium hydroxide is used, not only the etching rates of the non-doped oxide films and the doped oxide films become substantially the same, but also the cleaning liquid can be highly purified so that metallic impurities or fine particles in the liquid are decreased to a level required for the production of semiconductors.

An amount of the organic alkaline amine compound in the cleaning liquid is preferably from 0.0001 to 5.0% by weight, more preferably from 0.001 to 1.0% by weight.

When the amount of the organic alkaline amine compound is less than 0.0001% by weight, the ability of the liquid to remove the fine particles may deteriorate. When the amount of the organic alkaline amine compound exceeds 5.0% by weight, the difference of the etching rate between the doped oxide films and the non-doped oxide films may increase.

In addition to the above organic alkaline amine compound, the cleaning liquid of the present invention contains hydrogen peroxide.

An amount of hydrogen peroxide in the cleaning liquid is preferably from 0.01 to 20% by weight, more preferably from 0.1 to 5% by weight. When the amount of hydrogen peroxide is less than 0.01% by weight, the etching of the doped and non-doped oxide films tend to accelerated with the organic alkaline amine compound. When the amount of hydrogen peroxide exceeds 20% by weight, the cost of the cleaning liquid increases, and the effect to remove contaminants may deteriorate.

The cleaning liquid of the present invention is preferably used to clean the substrate having, on its surface, a plurality of exposed insulating films comprising silicon dioxide containing impurities in different concentrations.

Herein, the impurity in the substrate is at least one of boron and phosphorus.

To prepare the cleaning liquid of the present invention, the prescribed amounts of the organic alkaline amine compound, hydrogen peroxide and water are simply mixed by any mixing method.

A substrate may be cleaned with the cleaning liquid of the present invention at a temperature of 30 to 80° C. Furthermore, the cleaning of the substrate is preferably carried out while applying ultrasonic vibration to the cleaning liquid.

The cleaning liquid of the present invention can be used not only as a cleaner but also as an etchant.

In addition, the cleaning liquid of the present invention may be used to clean wiring grooves in addition to the contact holes.

The cleaning liquid of the present invention can effectively remove the contaminants from the substrate having, on its surface, a plurality of exposed insulating films comprising silicon dioxide containing impurities in different concentrations without forming steps between these two types of oxide films, so that a smooth cleaned surface can be attained.

Accordingly, the filling of the contact holes or wiring grooves with conductive materials can be facilitated, and also the adhesion of etching residues to the stepped parts can be avoided.

### EXAMPLES

The present invention will be illustrated by the following examples, which do not limit the scope of the invention in any way.

### Example 1 and Comparative Example 1

Tetramethylammonium hydroxide was added to a 5 wt. % aqueous solution of hydrogen peroxide in such an amount that pH reached 10.4 to obtain a cleaning liquid. Then, a semiconductor substrate on which a SiO₂ film (non-doped oxide film, thickness: 3,000 Å) had been formed by the CVD (chemical vapor deposition) method, and another semiconductor substrate on which a boron-phosphorus doped oxide film (BPSG doped oxide film, thickness: 5,000 Å) were dipped in and cleaned with the above cleaning liquid at 70° C. for 10 minutes. The thickness of each silicon oxide film was measured before and after cleaning, and an etching rate (Å/min.) of each film was calculated from the decrease of the thickness. The results are shown in Table 1.

In Comparative Example 1, the same substrates as those used in Example 1 were etched with a mixture of aqueous ammonia and an aqueous solution of hydrogen peroxide, that is, an APM cleaning liquid, as a cleaning liquid.

When the cleaning liquid containing tetramethylammonium hydroxide of Example 1 was used, the etching rate of the doped oxide film was the same as that of the non-doped film. However, when the conventional AMP cleaning liquid of Comparative Example 1 was used, the etching rate of the doped oxide film was ten times larger than that of the non-doped film.

### Example 2

The same substrates as those used in Example 1 were etched with a cleaning liquid having the same composition as that of Example 1 except that isopropanolamine was used in place of tetramethylammonium hydroxide. The etching rates are shown in Table 1.

The etching rate of the doped oxide film was only three times larger than that of the non-doped film. That is, the etching selectivity was about one third (⅓) in comparison to the APM cleaning liquid of Comparative Example 1.

### Example 3

The same substrates as those used in Example 1 were etched with a cleaning liquid having the same composition as that of Example 1 except that ethylenediamine was used in place of tetramethylammonium hydroxide. The etching rates are shown in Table 1.

The etching rate of the doped oxide film was only 3.4 times larger than that of the non-doped film. That is, the etching selectivity was about one third (⅓) in comparison to the APM cleaning liquid of Comparative Example 1.

TABLE 1

| | Ex. 1 | Ex. 2 | Ex. 3 | C. Ex. 1 |
|---|---|---|---|---|
| Cleaning liquid | | | | |
| Compound¹⁾ | (a) | (b) | (c) | (d) |
| Concentration of | 0.9 | 9.9 | 4.3 | 1.0 |
| compound (wt. %) | | | | |
| pH | 10.4 | 10.4 | 10.4 | 10.5 |
| Etching rate (Å/mm.) | | | | |
| Non-doped oxide film | 2 | 4 | 5 | 3 |
| Doped oxide film | 2 | 12 | 17 | 33 |

Note: 1) (a) Tetramethylammonium hydroxide.
(b) Isopropanolamine.
(c) Ethylenediamine.
(d) Aqueous ammonia.

### Example 4 and Comparative Example 2

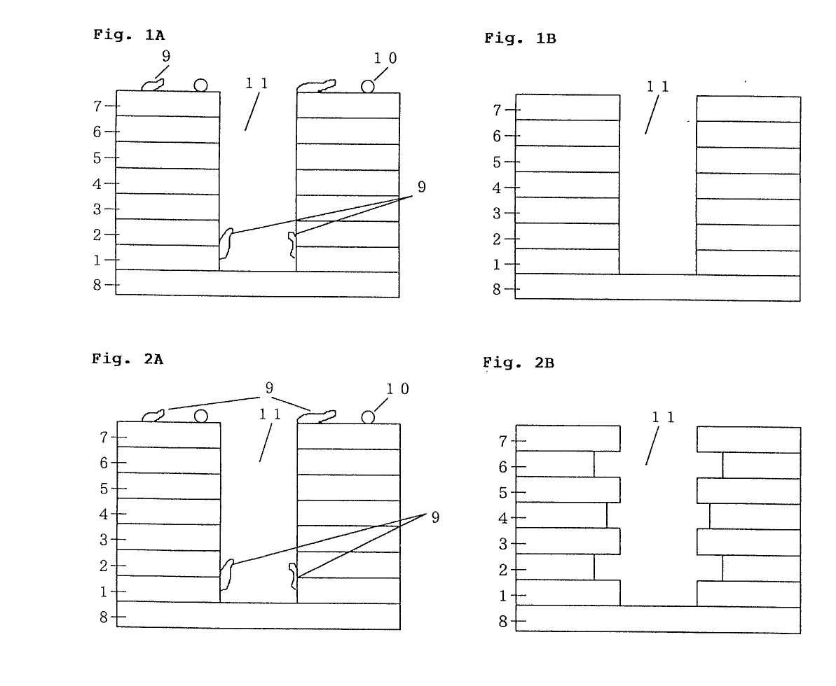

On a silicon substrate 8 shown in FIG. 1, a NSG oxide film 1 having a thickness of 0.3 μm, a BPSG oxide film 2 (B: 11 mole %, P: 4.5 mole %) having a thickness of 0.3 μm, a NSG oxide film 3 having a thickness of 0.3 μm, a low-concentration doped oxide film 4 (B: 0.2 mole %, P: 0.3 mole %) having a thickness of 0.2 μm, a NSG oxide film 5 having a thickness of 0.3 μm, a BPSG oxide film 6 (B: 11 mole %, P: 4.5 mole %) having a thickness of 0.4 μm, and a NSG oxide film 7 having a thickness of 0.2 μm were successively formed. Then, a hole having a diameter of 0.3 μm was perforated by dry etching. After that, most of the resist used for patterning was removed by ashing with microwave oxygen plasma (250° C., 1 minute) and cleaning with a mixture of sulfuric acid and hydrogen peroxide (sulfuric acid:hydrogen peroxide=4:1 by volume, 130° C., 5 minutes), as shown in FIG. 1A. However, the deposits 9 formed by dry etching and the particulate contaminants 10 were as not removed, and remained on the surface outside the hole, and also in the hole.

The semiconductor substrate carrying the deposits and contaminants was cleaned with the cleaning liquid of Example 1 or Comparative Example 1 at 70° C. for 10 minutes.

The scanning electron microscopic photograph of the cross section of the hole after cleaning confirmed that the deposits were removed with the cleaning liquid of Example 1 or that of Comparative Example 1.

In addition, the particulate contaminants 10 were also removed to obtain the cleaned structure. The height of the step formed between the BPSG oxide film 2 and the NSG oxide film 3, and also the height of the step formed between the low-concentration doped BPSG oxide film 4 and the NSG oxide film 5 were measured. The results are shown in Table 2 as Example 4 and Comparative Example 2.

As shown in FIG. 1B, no step was observed on the inner wall of the hole pierced in the substrate which was treated with the cleaning liquid of Example 1, and the inner wall surface was in good conditions. However, in the substrate treated with the cleaning liquid of Comparative Example 1 shown in FIG. 2B, the step having a height of about 400 Å was formed between the BPSG oxide film and the NSG oxide film, and the step having a height of about 170Å was formed between the low-concentration doped oxide film and the NSG oxide film.

TABLE 2
Height of step

| | Example 4 | C. Ex. 2 |
|---|---|---|
| BPSG oxide film/NSG oxide film | <100 Å | 400 |
| Low-cont. doped oxide film/ | <100 Å | 170 |
| NSG oxide film | | |

We claim:

1. A method for cleaning a semiconductor substrate, comprising the steps of:
placing a cleaning liquid on an exposed insulating film on the semiconductor surface, wherein the exposed insulating film comprising a plurality of silicon dioxide layers, said exposed insulating film having at least one exposed hole opening that exposes the plurality of silicon dioxide layers, said plurality of silicon dioxide layers contain impurities in different concentrations;
cleaning said semiconductor substrate; and
removing the cleaning liquid from the semiconductor surface, wherein the cleaning liquid comprises an organic alkaline amine and hydrogen peroxide.

2. The method according to claim 1, wherein, during the cleaning step, ultrasonic vibration is applied to the substrate.

3. The method according to claim 1, wherein said organic alkaline amine compound is at least one compound selected from the group consisting of tetraalkylammonium hydroxides.

4. The method according to claim 3, wherein tetraalkylammonium hydroxide is at least one compound selected from the group consisting of tetramethylammonium hydroxide, tetraethylammonium hydroxide and tertapropylammonium hydroxide.

5. The method according to claim 1, wherein said organic alkaline amine compound is at least one compound selected from the group consisting of monoethylamine, dimethylamine, trimethylamine, monoethylamine, diethylamine, triethylamine, monoethanolamine, diethanolamine, triethanolamine, isopropylamine amine, diisopropylamine, triisopropylamine, isopropanolamine, diisopropanolaminem triisopropanolamine, ethylenediamine, diethylenetriamine, triethylenetetramine and tetraethylpentamine.

6. The method according to claim 1, wherein an amount of said organic alkaline amine compound is from 0.0001 to 5.0% by weight, and an amount of hydrogen peroxide is from 0.01 to 20% by weight, based on the whole cleaning liquid.

7. The method according to claim 1, wherein said impurity is at least one element selected from the group consisting of boron and phosphorous.
